(19) United States
(12) Patent Application Publication
(10) Pub. No.: US 2025/0116961 A1
(43) Pub. Date: Apr. 10, 2025

(54) PRINTER

(71) Applicant: KINPO ELECTRONICS, INC., New Taipei City (TW)

(72) Inventor: Chen-Hao CHUNG, New Taipei City (TW)

(21) Appl. No.: 18/539,933

(22) Filed: Dec. 14, 2023

(30) Foreign Application Priority Data
Oct. 6, 2023 (TW) 112138526

(51) Int. Cl. G03G 21/16

(52) U.S. Cl. CPC G03G 21/1652; G03G 21/1619; G03G 21/1647

(57) ABSTRACT

A printer for connecting an operation module includes a machine body and a plug. The machine body has a carrying plane for carrying the operation module and a supporting plane for supporting the operation module. The supporting plane is upright disposed at a side of the carrying plane. The plug is used for connecting the operation module and disposed on the body corresponds to the carrying plane. A plugging direction of the plug is defined parallel to the supporting plane.

### BACKGROUND

### 1. Technical Field

The disclosure relates to a printer, particularly to a printer with a replaceable operation module.

### 2. Description of Related Art

In current daily life, printers are commonly used in homes or offices. A conventional multi-functional printer generally has a touch screen as a user interface. Generally speaking, regarding damages during a part aging process of a printer, mechanical components are damaged firstly, and a touch screen failure is unusual. However, an operable touch screen is abandoned with a failure printer when replacing a new one. A large amount of touch screen waste leads to serious damage to the environment.

In view of this, the inventors have devoted themselves to the above-mentioned prior art, researched intensively and cooperated with the application of science to try to solve the above-mentioned problems. Finally, the invention which is reasonable and effective to overcome the above drawbacks is provided.

### SUMMARY

The disclosure provides a printer having a replaceable operation module.

The disclosure provides a printer for connecting an operation module, which includes a machine body and a plug. The machine body has a carrying plane for carrying the operation module and a supporting plane for supporting the operation module. The supporting plane is upright disposed at a side of the carrying plane. The plug is used for connecting the operation module and corresponds to the carrying plane to be disposed on the body. A plugging direction of the plug is defined parallel to the supporting plane.

In an embodiment of the disclosure, the printer further includes a slidable block, the machine body includes a track structure, the slidable block is disposed on the track structure and movable along a normal direction of the carrying plane, and the plug is disposed on the slidable block.

In an embodiment of the disclosure, the machine body includes a recess, and the carrying plane and the supporting plane are separately formed in the recess. The recess is disposed on a corner or a side edge of a top of the machine body.

In an embodiment of the disclosure, the plug may be disposed on the carrying plane or at a side of the carrying plane.

In an embodiment of the disclosure, the printer further includes a main board which is disposed in the machine body and electrically connected with the plug through a wire.

In an embodiment of the disclosure, the printer further includes an adapter which is connected with the plug and used to be inserted into a jack.

In an embodiment of the disclosure, the plug is detachably disposed on the machine body.

The disclosure provides another printer, which includes a machine body, a plug, and an operation module. The machine body has a carrying plane and a supporting plane. The supporting plane is upright disposed at a side of the carrying plane. The plug corresponds to the carrying plane to be disposed on the body. A plugging direction of the plug is parallel to the supporting plane. The operation module includes a body, an operation interface, and a jack. The operation interface is disposed at a side of the body. The jack is disposed on the body and located at a side of the operation interface. The body is placed on the carrying plane and the supporting plane abuts against another side of the body, which is opposite to the operation interface. The plug is plugged into the jack.

In an embodiment of the disclosure, the printer further includes a slidable block, the machine body includes a track structure, the slidable block is disposed on the track structure and movable along a normal direction of the carrying plane, and the plug is disposed on the slidable block.

In an embodiment of the disclosure, the machine body includes a recess, and the carrying plane and the supporting plane are separately formed in the recess.

In an embodiment of the disclosure, the body is received in the recess to close the recess, and a contour of the body continues a contour of the machine body.

In an embodiment of the disclosure, the recess is disposed on a corner or a side edge of a top of the machine body.

In an embodiment of the disclosure, the plug may be disposed on the carrying plane or at a side of the carrying plane.

In an embodiment of the disclosure, the printer further includes a main board which is disposed in the machine body and electrically connected with the plug through a wire.

In an embodiment of the disclosure, the printer further includes an adapter which is connected with the plug and plugged into the jack.

In an embodiment of the disclosure, the plug is detachably disposed on the machine body.

A user may purchase the printer of the disclosure which may not have a, the attached operation module. The user may use his or her own smartphone to serve as the operation module. The user may also transfer the attached operation module of an old printer to a new printer to use.

### BRIEF DESCRIPTION OF THE DRAWINGS

FIGS. 1-3 are schematic views of the first embodiment of the disclosure;

FIG. 4 is a schematic view of another using status of the first embodiment of the disclosure;

FIGS. 5-6 are schematic views of the second embodiment of the disclosure;

FIGS. 7-8 are schematic views of another using status of the second embodiment of the disclosure; and

FIG. 9 is a schematic view of still another using status of the second embodiment of the disclosure.

### DETAILED DESCRIPTION

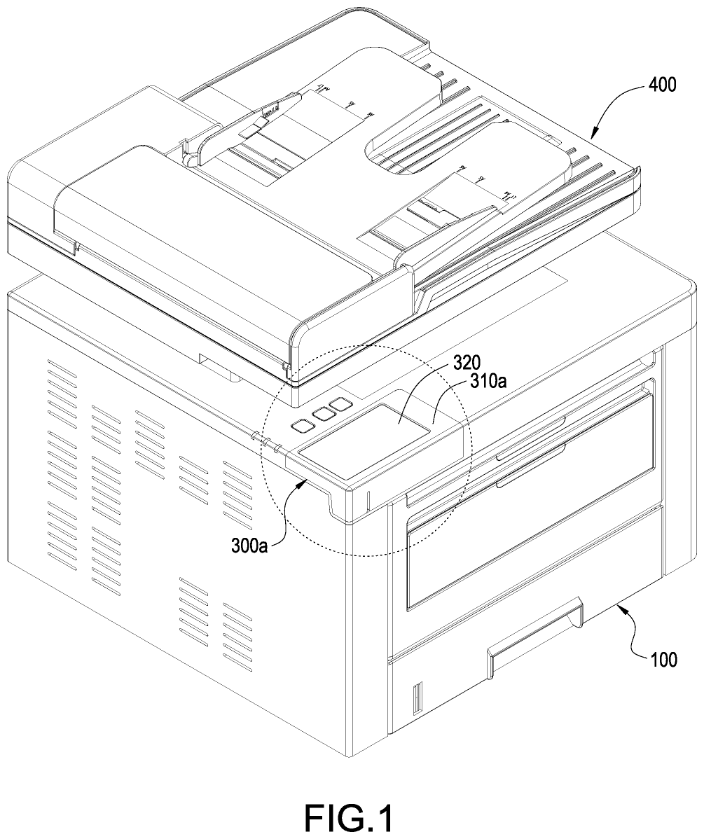

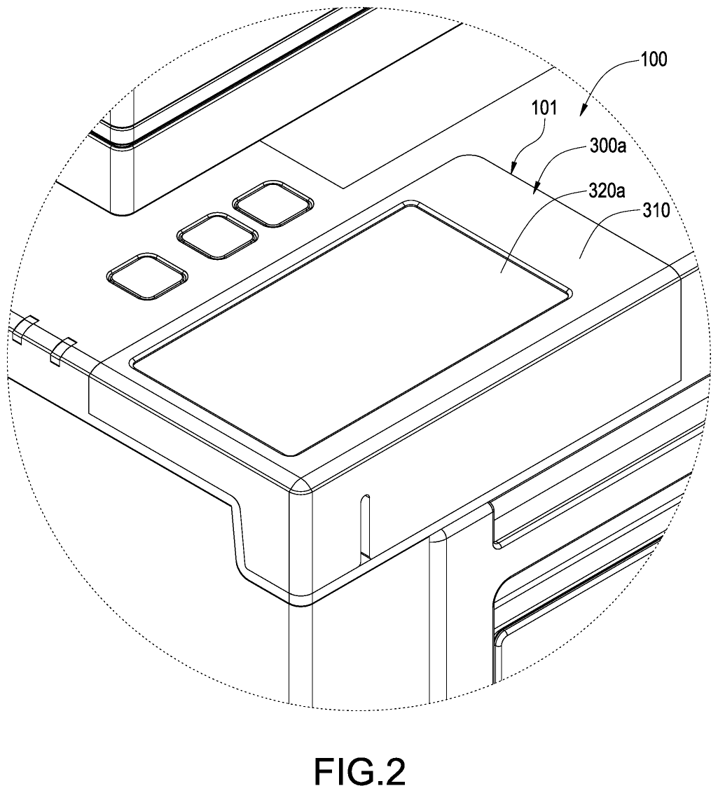

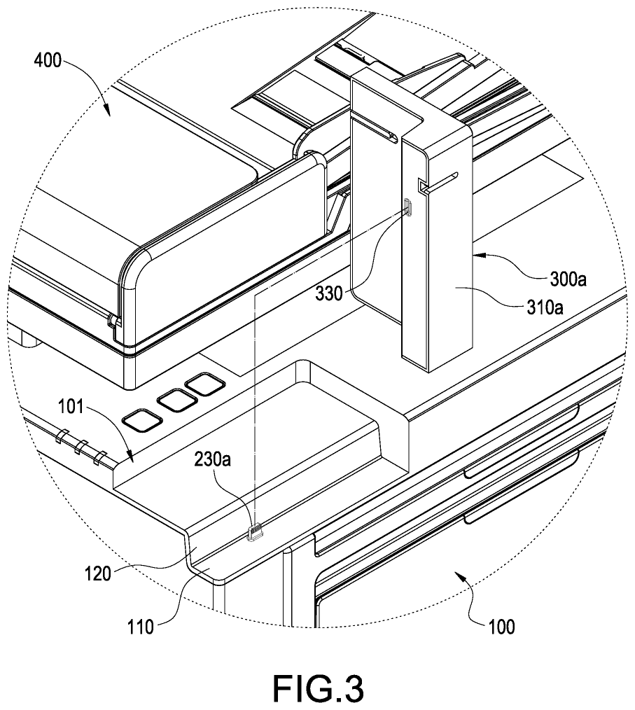

Please refer to FIGS. 1-3. The first embodiment of the disclosure provides a printer which includes a machine body 100 and a plug 230a. The printer may optionally include an operation module 300a. The printer may also optionally include a paper feeding module 400.

The machine body 100 has a carrying plane 110 and a supporting plane 120. The supporting plane 120 is upright disposed at a side of the carrying plane 110, i.e., the supporting plane 120 is located at a side of the carrying plane 110 and is disposed perpendicular to the carrying plane 110 or slightly slant to the normal of the carrying plane 110. Each of the carrying plane 110 and the supporting plane 120 is a plane defined by at least three substantial points. The operation module 300a can be placed on the plane. The implementation of the carrying plane 110 and the supporting plane 120 is not limited to a flat substantial plane.

In the embodiment, the carrying plane 110 is adjacent to and perpendicular to the supporting plane 120. In the embodiment, the machine body 100 includes a recess 101. The recess 101 may be disposed on a side edge of the top of the machine body 100 or a on corner of the top of the machine body 100 namely a junction of multiple side edges. The carrying plane 110 and the supporting plane 120 are separately formed in the recess 101. The carrying plane 110 and the supporting plane 120 may be separated from each other or adjacent to each other.

The plug 230a is disposed on the machine body 100 corresponding to the carrying plane 110. In the embodiment, the plug 230a is disposed on the carrying plane 110 and a plugging direction of the plug 230a is defined parallel to the supporting plane 120, but the disclosure is not limited to this.

In the embodiment, the operation module 300a may be an operation module 300a attached on the machine body 100. The operation module 300a includes a body 310a, an operation interface 320 and a jack 330. The operation interface 320 is a touch screen disposed at one side of the body 310a. The jack 330 is disposed on the body 310a and located at a side of the operation interface 320. The body 310a is placed on the carrying plane 110 and the supporting plane 120 abuts against another side of the body 310a, which is opposite to the operation interface 320. In the embodiment, the body 310a of the operation module 300a is received in the recess 101 to close the recess 101. The plug 230a is plugged into the jack 330. A contour of the body 310a is continuously connected with a contour of the machine body 100. The operation interface 320 is exposed.

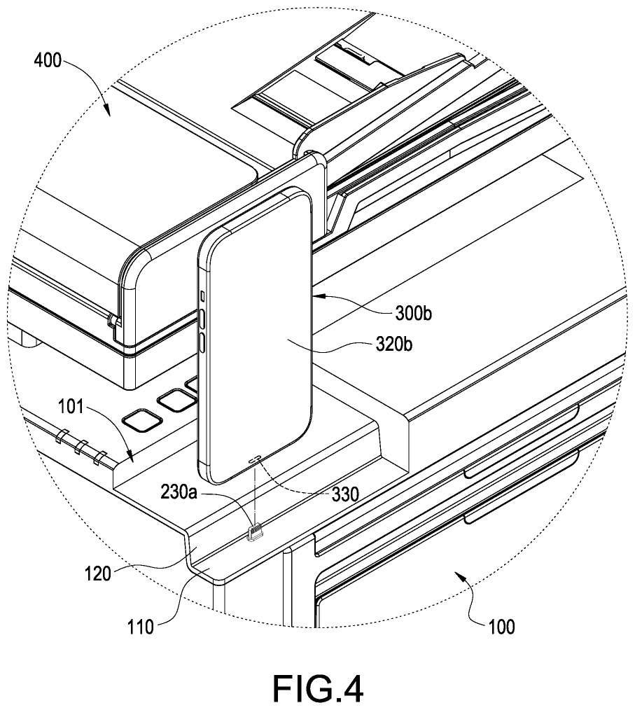

In the embodiment, the operation module 300a as shown in FIG. 1 may also be alternatively a smartphone. In the embodiment, as shown in FIG. 4, the smartphone-type operation module 300b includes a body 310b, an operation interface 320 and a jack 330. The body 310b is of a flat rectangular shape. The operation interface 320 is a touch screen and disposed at a side of the body 310b. The jack 330 is disposed on a bottom edge of the body 310b so as to be located on the bottom side of the operation interface 320. In the embodiment, the bottom of the body 310b of the operation module 300b is received in the recess 101. The bottom edge of the body 310b is placed on the carrying plane 110. The plug 230a is plugged into the jack 330. The supporting plane 120 abuts against the other side of the body 310b, which is opposite to the operation interface 320 to support the body 310b to stand up.

Thus, when a user is buying a printer, the pre-built operation module 300a as shown in the first embodiment may not be included. In the embodiment, the user may use his or her own smartphone to serve as the operation module 300b.

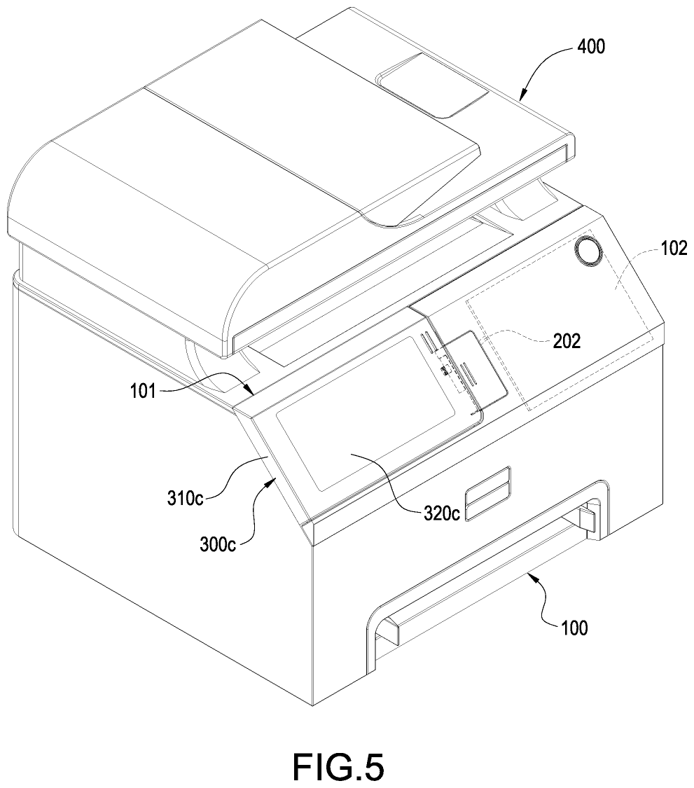

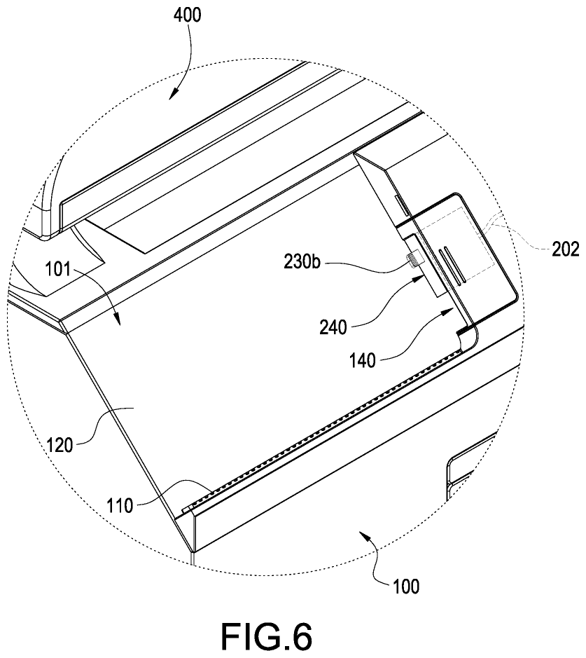

Please refer to FIGS. 5-6, the second embodiment of the disclosure provides a printer, which includes a machine body 100 and a plug 230b. The printer may optionally include an operation module 300c. The printer may also optionally include a paper feeding module 400.

The machine body 100 has a carrying plane 110 and a supporting plane 120. The carrying plane 110 is adjacent to and perpendicular to the supporting plane 120. In the embodiment, the machine body 100 includes a recess 101. The recess 101 may be disposed on a side edge of the top of the machine body 100 or on a corner of the top of the machine body 100 namely a junction of multiple side edges. The carrying plane 110 and the supporting plane 120 are separately formed in the recess 101. The carrying plane 110 and the supporting plane 120 may be separated from each other or adjacently to each other.

The plug 230b is disposed on the machine body 100 and allowed to be replaced with various types of connectors. The plug 230b corresponds to the carrying plane 110. In the embodiment, the plug 230b is disposed at a side of the carrying plane 110 and a plugging direction of the plug 230b is parallel to the supporting plane 120, but the disclosure is not limited to this.

In the embodiment, the operation module 300c may be a pre-built operation module 300c. The operation module 300c includes a body 310c, an operation interface 320 and a jack 330. The operation interface 320 is a touch screen and disposed at one side of the body 310c. The jack 330 is disposed on the body 310c and located at a side of the operation interface 320. The body 310c is placed on the carrying plane 110 and the supporting plane 120 abuts against another side of the body 310c, which is opposite to the operation interface 320. In the embodiment, the body 310c of the operation module 300c is received in the recess 101 to close the recess 101. The plug 230b is plugged into the jack 330. A contour of the body 310c is continuously connected with a contour of the machine body 100. The operation interface 320 is exposed.

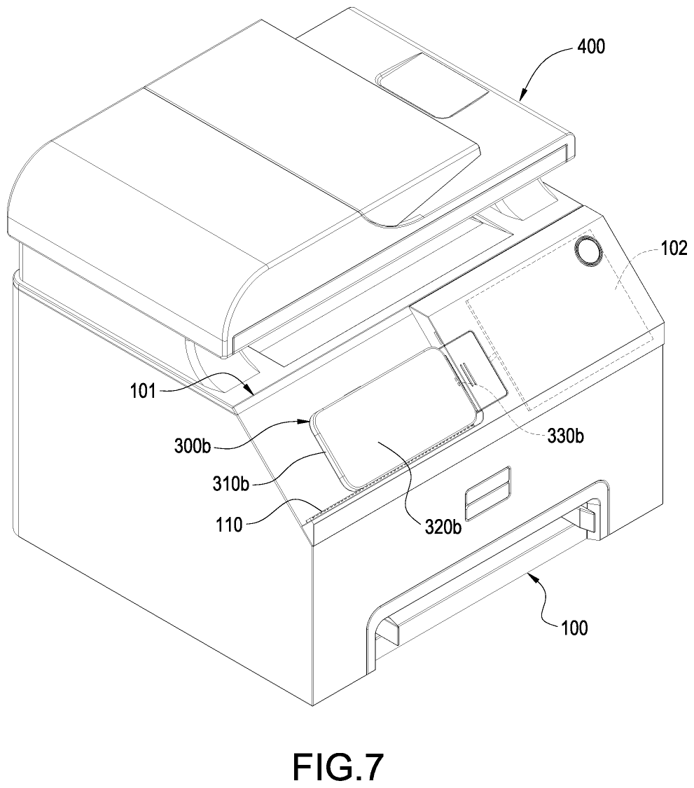

In the embodiment, the operation module 300 as shown in FIG. 5 may also be alternatively a smartphone. As shown in FIGS. 6 and 7, the smartphone-type operation module 300b includes a body 310b, an operation interface 320 and a jack 330. The body 310b is of a flat rectangular shape. The operation interface 320 is a touch screen disposed at one side of the body 310b. The jack 330 is disposed on the bottom edge of the body 310b to be located on the bottom side of the operation interface 320. In the embodiment, the operation module 300b is horizontally received in the recess 101. The side of the body 310b is received in the recess 101 and the side edge of this side of the body 310b is placed on the carrying plane 110. The supporting plane 120 abuts against another side of the body 310b, which is opposite to the operation interface 320 to support the body 310b to stand up.

In the embodiment, the machine body 100 includes a track structure 140. At least part of the track structure 140 extends along the normal direction of the carrying plane 110. The track structure 140 is disposed with a slidable block 240 which is movable along the track structure 140. The plug 230b is disposed on the slidable block 240 to be able to adjust the distance between the plug 230b and the carrying plane 110 by moving the slidable block 240 so as to align with the jack 330 of the operation module 300b.

In the embodiment, the printer further includes a main board 102. The main board 102 is disposed in the machine body 100. The plug 230b is electrically connected with the main board 102 through a wire 202. As a result, the plug 230b can still be electrically connected with the main board 102 while the plug 230b is moving.

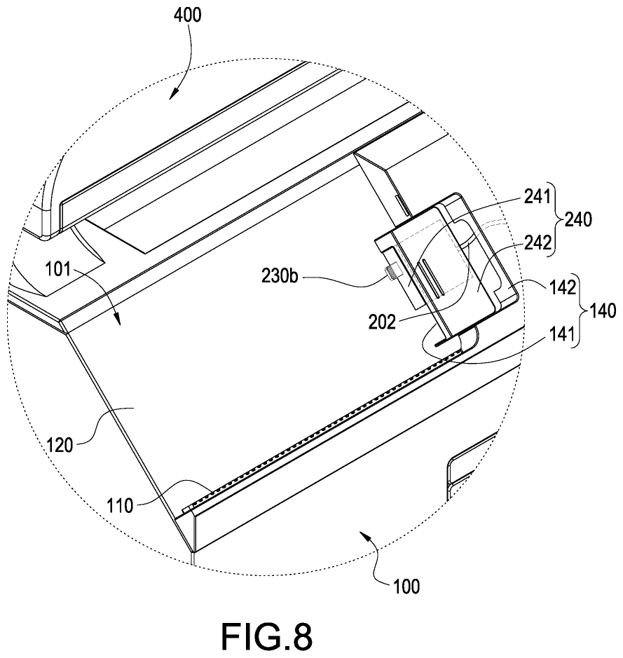

Please refer to FIG. 8. In the embodiment, the slidable block 240 may include a main slider 241 and a sub-slider 242. The track structure 140 includes a first rail segment 141 and a second rail segment 142. The first rail segment 141 is disposed on the main slider 241. The second rail segment 142 is directly disposed on the machine body 100. The first rail segment 141 extends along a direction parallel to the carrying plane 110 and is perpendicular to the second rail segment 142 on the machine body 100. The plug 230b is disposed on the sub-slider 242 to be movable along the two directions which are perpendicular and parallel to the carrying plane 110 respectively, thereby aligning with the plug 330 of the operation module 300b.

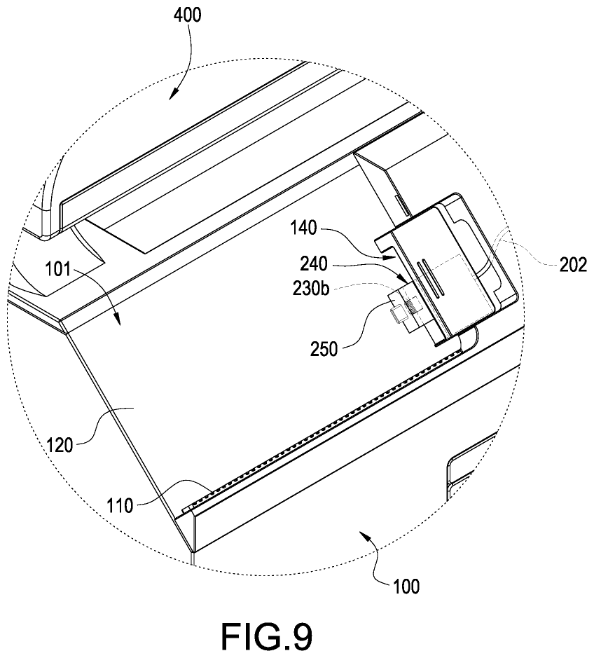

Please refer to FIG. 9. The printer may further include an adapter 250. The adapter 250 is connected with the plug 230b and plugged into the jack 330 to convert different connectors.

The user may purchase a printer without the attached operation module 300a/300c. The user may use his or her own smartphone to serve as the operation module 300b. The user may also use an attached operation module 300a/300c transferred from a previous printer to a new printer. Thus, the decreasing of the waste touch screens may reduce the damage to the environment, and the manufacturing costs of printers and the purchasing loading of users can also be reduced.

While this disclosure has been described by means of specific embodiments, numerous modifications and variations could be made thereto by those skilled in the art without departing from the scope and spirit of this disclosure set forth in the claims.

What is claimed is:

1. A printer for connecting an operation module, comprising:
a machine body, having a carrying plane for carrying the operation module and a supporting plane for supporting the operation module, and the supporting plane being upright disposed at a side of the carrying plane; and
a plug for connecting the operation module, disposed on the body corresponding to the carrying plane, and a plugging direction of the plug being defined parallel to the supporting plane.

2. The printer of claim 1, further comprising a slidable block, wherein the machine body comprises a track structure, the slidable block is disposed on the track structure and movable along a normal direction of the carrying plane, and the plug is disposed on the slidable block.

3. The printer of claim 1, wherein the machine body comprises a recess, and the carrying plane and the supporting plane are separately formed in the recess.

4. The printer of claim 3, wherein the recess is disposed on a corner or a side edge of a top of the machine body.

5. The printer of claim 1, wherein the plug is disposed on the carrying plane.

6. The printer of claim 1, wherein the plug is disposed at a side of the carrying plane.

7. The printer of claim 1, further comprising a main board which is disposed in the machine body and electrically connected with the plug through a wire.

8. The printer of claim 1, further comprising an adapter which is connected with the plug and used to be inserted into a jack.

9. The printer of claim 1, wherein the plug is detachably disposed on the machine body.

10. A printer comprising:
a machine body, having a carrying plane and a supporting plane, and the supporting plane being upright disposed at a side of the carrying plane;
a plug, disposed on the body corresponding to the carrying plane, and a plugging direction of the plug being defined parallel to the supporting plane; and
an operation module, comprising a body, an operation interface and a jack, the operation interface being disposed at a side of the body, the jack being disposed on the body and located at a side of the operation interface, the body being placed on the carrying plane and the supporting plane abutting against another side of the body, which is opposite to the operation interface, and the plug being plugged into the jack.

11. The printer of claim 10, further comprising a slidable block, wherein the machine body comprises a track structure, the slidable block is disposed on the track structure and movable along a normal direction of the carrying plane, and the plug is disposed on the slidable block.

12. The printer of claim 10, wherein the machine body comprises a recess, and the carrying plane and the supporting plane are separately formed in the recess.

13. The printer of claim 12, wherein the body is received in the recess to close the recess, and a contour of the body continues a contour of the machine body.

14. The printer of claim 12, wherein the recess is disposed on a corner or a side edge of a top of the machine body.

15. The printer of claim 10, wherein the plug is disposed on the carrying plane.

16. The printer of claim 10, wherein the plug is disposed at a side of the carrying plane.

17. The printer of claim 10, further comprising a main board which is disposed in the machine body and electrically connected with the plug through a wire.

18. The printer of claim 10, further comprising an adapter which is connected with the plug and inserted into the jack.

19. The printer of claim 10, wherein the plug is detachably disposed on the machine body.
